(19) United States
(12) Patent Application Publication
(10) Pub. No.: US 2021/0215815 A1
(43) Pub. Date: Jul. 15, 2021

(54) ANGLE-RESOLVING RADAR SENSOR

(71) Applicant: Robert Bosch GmbH, Stuttgart (DE)

(72) Inventors: Marcel Mayer, Lonsee (DE); Michael Schoor, Stuttgart (DE)

(21) Appl. No.: 17/054,919

(22) PCT Filed: Jun. 18, 2019
(86) PCT No.: PCT/EP2019/065959

§ 371 Date: Nov. 12, 2020

(30) Foreign Application Priority Data
Sep. 4, 2018 (DE) 10 2018 214 966.6

(51) Int. Cl. G01S 13/34; H01Q 21/06; G01S 13/931

(52) U.S. Cl. CPC G01S 13/345; G01S 2013/0245; G01S 13/931; H01Q 21/065

(57) ABSTRACT

An angle-resolving radar sensor including an antenna array, which includes a number N of antenna elements offset relative to one another in a scanning direction, a digital beam forming device, and an angle estimating device, which is designed to estimate an angle on the basis of the signal of the beam forming device. The aperture A of the antenna array is greater than (N−1)/2 in units of the wavelength, and the center-to-center distances between the adjacent antenna elements differ from one another, but deviate by not more than a predetermined degree of the value A/(N−1).

### FIELD

The present invention relates to an angle-resolving radar sensor including an antenna array, which includes a number N of antenna elements offset relative to one another in a scanning direction, a beam forming device and an angle estimating device, which is designed to estimate an angle on the basis of the signal of the beam-forming device.

### BACKGROUND INFORMATION

Radar sensors are used in motor vehicles, for example, to measure distances, relative velocities and azimuth angles of vehicles or other objects located ahead of the ego vehicle. The individual antenna elements are then situated, for example, on a horizontal at a distance to one another in such a way that different azimuth angles of the located objects result in differences in the run lengths, which the radar signals must travel from the object to the respective antenna element. These run length differences result in corresponding differences in the phase of the signals, which are received by the antenna elements and evaluated in the associated evaluation channels. By comparing the (complex) amplitudes received in the various channels with corresponding amplitudes in an antenna diagram, it is then possible to determine the incidence angle of the radar signal and thus the azimuth angle of the located object.

Elevation angles of objects may also be measured in a similar manner. The scanning direction, in which the antenna elements are offset relative to one another, is then the vertical, rather than the horizontal.

In order to achieve a high angle resolution, the aperture of the antenna should be preferably large. If, however, the distances between the adjacent antenna elements are too large, ambiguities in the angle measurement may occur, since the same phase relationships between the received signals are obtained for propagation time differences, which differ by integer multiples of the wavelength λ. An unambiguous angle measurement may be achieved, for example, with a ULA structure (uniform linear array), in which the antenna elements are situated at distances of λ/2.

With the aid of a procedure, referred to as digital beam forming, it is possible to modify the main sensitivity direction of the antenna array and thus virtually direct the main reception lobe of the radar sensor in a particular direction, secondary lobes having a certain sensitivity however also occurring on both sides of the main reception lobe. During the digital beam forming, the complex amplitudes received by each individual antenna element are weighted with an angle-dependent complex phase factor, which corresponds to the propagation time difference of the radar radiation for the given angle. If multiple beams having different direction angles are formed in this way, a gain function is then obtained for each beam, which indicates for each angle the antenna gain that would result if the located object were located at the relevant angle. Ideally, for an object located at a particular angle, a signal strength should be measured in each beam, which corresponds to the theoretical antenna gain for this beam, and only at exactly one angle, namely, the angle at which the object is actually located, should the measured amplitudes have the correct relationship to one another.

In practice, however, the measured signals are more or less noisy, so that the positioning angle may only be estimated by finding the angle for which the amplitudes measured in the various beams best correlate with the theoretical values. This correlation may be expressed, for example, by a so-called DML function (Deterministic Maximum Likelihood Function), and the angle estimation involves finding the maximum of the DML function.

If the aperture of the antenna array is enlarged in order to achieve a higher angle resolution, and if the measurement is nevertheless to remain unambiguous, then the number of antenna elements must be increased. With that, however, the number of the required evaluation channels also increases, so that the required computing power and thus the hardware costs increase.

A radar sensor is described in PCT Application No. WO2013/056880 A1, which operates with thinned out antenna arrays, in which the distances at least for some of the pairs of adjacent antenna elements are increased, so that with a given number of evaluation channels a larger aperture is obtained. The unambiguity of the angle measurement is than re-established in that measurements are made alternatingly with various combinations of antenna elements, as a result of which the gaps in the antenna array are filled.

### SUMMARY

An object of the present invention is to provide an angle-resolving radar sensor, with which a high-resolving unambiguous angle measurement is possible with reduced computing time for the signal evaluation.

The object may be achieved according to the present invention in that aperture A of the antenna array is greater than (N−1)/2 in units of wavelength λ and that the center-to-center distances between the adjacent antenna elements differ from one another, but deviate by not more than a predetermined degree of the value A/(N−1).

Since the aperture is greater than (N−1)/2, ambiguities may, in principle, occur during the angle estimation. In the DML function for a ULA, this is manifested in the fact that the function includes multiple equally high maxima at different angles. Because, according to the present invention, the antenna elements are not situated exactly at uniform distances, but the distances from pair to pair differ somewhat from one another, all maxima except for one are reduced in height in the DML function, so that the function again exhibits an unambiguous absolute maximum, and an unambiguous angle estimation is thus possible. The deviation of the antenna distances from value A/(N−1), which would correspond to the distance in a ULA, is however, delimited in such a way that the same technologies may still be used for digital beam forming as in a ULA and the secondary lobes are sufficiently attenuated. The digital beam forming may, in particular, take place in a particularly efficient manner via a fast Fourier transform (FFT).

Thus, instead of a ULA, the radar sensor according to the present invention includes a virtual regular array, in which the deviations from a perfect ULA are just large enough that, given the noise level to be expected, an unambiguous angle estimation is still possible. The “predetermined degree” by which the distances of the antenna elements may maximally differ from the ULA value A/(N−1) is selected in this case in such a way that, on the one hand, a sufficient robustness with respect to the signal noise is achieved, on the other hand, however, the angle-dependent gain functions with respect to a ULA are not too severely distorted.

Advantageous embodiments and refinements of the present invention are described herein.

In one specific embodiment of the present invention, the deviations of the center-to-center distances between the antenna elements from value A/(N−1) are smaller than 25%, absolutely, i.e., smaller than A/4 (N−1), the deviations are preferably smaller than 15%.

In this case, the deviations of the distances between the various pairs of adjacent antenna elements may in turn vary regularly, for example, according to a linear function, a quadratic function or also according to a polynomial of a higher degree or, for example, according to a sine function. The number N of the antenna elements of the array is preferably a power of two, i.e., for example, N=8 or N=16, as a result of which an efficient digital beam forming is enabled with the aid of an FFT.

### BRIEF DESCRIPTION OF THE DRAWINGS

One exemplary embodiment is explained in greater detail below with reference to the figures.

FIG. 1 shows a block diagram of a radar sensor according to an example embodiment of the present invention including a virtual regular antenna array.

FIG. 2 shows a representation of a regular antenna array (ULA) of a conventional radar sensor.

FIG. 3 shows gain distribution functions for various beams, which have been formed with the aid of digital beam forming using the antenna array according to FIG. 2.

FIG. 4 shows a simplified diagram similar to FIG. 3, in which, for reasons of clarity, only the gain functions for two beams are represented.

FIG. 5 shows a DML function for the antenna array according to FIG. 2.

FIG. 6 shows an example of a ULA including an enlarged aperture.

FIG. 7 shows a diagram of two gain functions similar to FIG. 4, but for the array according to FIG. 6.

FIG. 8 shows a DML function for the array according to FIG. 6.

FIG. 9 shows a diagram of two gain functions similar to FIGS. 4 and 7, but for the array according to the present invention according to FIG. 1.

FIG. 10 shows a DML function for the array according to FIG. 1.

### DETAILED DESCRIPTION OF EXAMPLE EMBODIMENTS

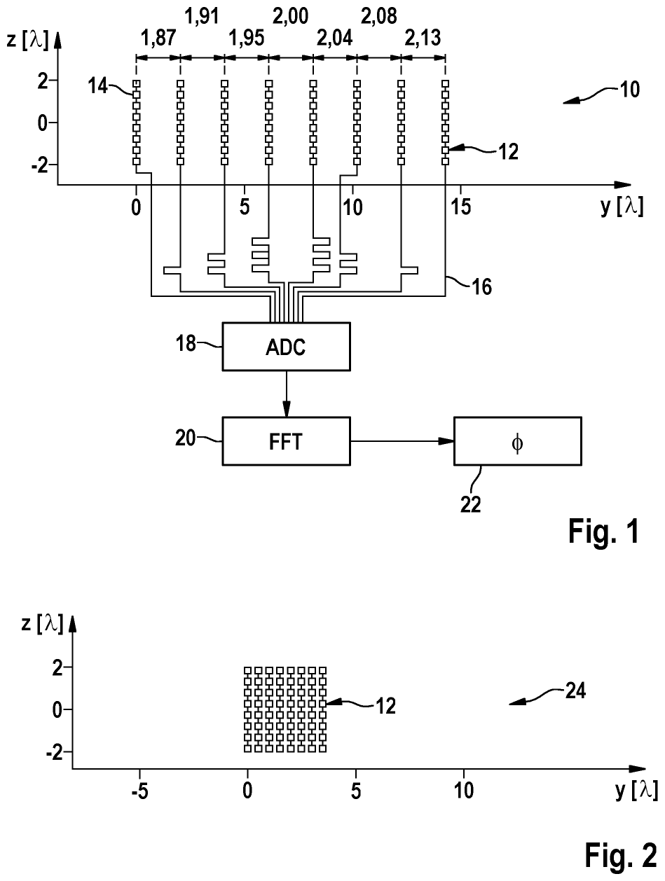

FIG. 1 shows a radar sensor in diagram form including a virtual regular antenna array 10 that includes eight antenna elements 12. Each antenna element 12 is formed by a column made up of eight serially fed antenna patches 14, which extend in vertical direction z. Antenna elements 12 in columns are situated in a row in a scanning direction y which, in a radar sensor for motor vehicles, corresponds to the horizontal transverse direction of the vehicle in such a way that the radar sensor has an angle resolving capacity in the azimuth. The distances between antenna elements 12 as well as the distances between individual antenna patches 14 of each column are indicated in units of the wavelength λ of the radar radiation. The distances between the pair-wise adjacent antenna elements 12 are also quantitatively indicated in FIG. 1 and each have approximately the value 2, however, with deviations of less than 7% of the average value 2.00.

The width of antenna array 10 in the scanning direction y is approximately 14λ, so that the array in the azimuth has the aperture A=14. In general, the average value (2.00 in this example) of the distances between antenna elements 12 is equal to A/N−1), if N is the number of antenna elements 12 in the array.

In the example shown, the distances between the pairs of antenna elements 12 increase linearly from 1.87 to 2.13.

Eight antenna elements 12 are connected via respective signal lines 16 to an evaluation circuit 18, in which the received signals are evaluated in separate receiving channels. The radar sensor shown here may be an FMCW radar (Frequency Modulated Continuous Wave). Each evaluation channel then contains a mixer, in which the signal received from the antenna element is mixed with a portion of the transmitted radar signal, so that an intermediate frequency signal is obtained, the frequency of which is a function, on the one hand, of the propagation time of the radar signal from the radar sensor to the object and back and, on the other hand, of the relative velocity of the object. The intermediate frequency signals are digitized in evaluation circuit 18 and each recorded over a certain sampling period, in which the frequency of the transmitted signal is ramp-shaped modulated. Based on the frequencies of the intermediate frequency signals, which are obtained on multiple modulation ramps with varying ramp slope, it is then possible to determine the distances and relative velocities of the located objects in a conventional manner.

Signal lines 16 connecting the antenna elements to evaluation circuit 18 are designed in such a way that they all have the same length, so that the phase relationships between the signals on the way to evaluation circuit 18 are not distorted. By comparing the amplitudes and phases (i.e., the complex amplitudes) of the signals received in the eight receiving channels, it is then possible to determine for each object, which is located at a particular distance and at a particular relative velocity, the angle (azimuth angle), which indicates the direction from the radar sensor to the object. For this purpose, the signals received in the eight receiving channels are subjected to a digital beam forming in a beam former 20, for example, with the aid of a fast Fourier transform (FFT). The results of the beam forming are conveyed to an angle estimating device 22, where azimuth angle ϕ of the located object is determined with the aid of a maximum likelihood estimation.

To explain the mode of operation of the present invention, a completely filled regular antenna array 24 (ULA) is initially considered, as it is used in conventional radar sensors and as it is shown in diagram form in FIG. 2. The distance between adjacent antenna elements 12 in this array is a uniform λ/2, so that the unambiguity condition is met. However, this array—with eight receiving channels—has only one aperture A=3.5, so that the angle resolution capacity is significantly limited.

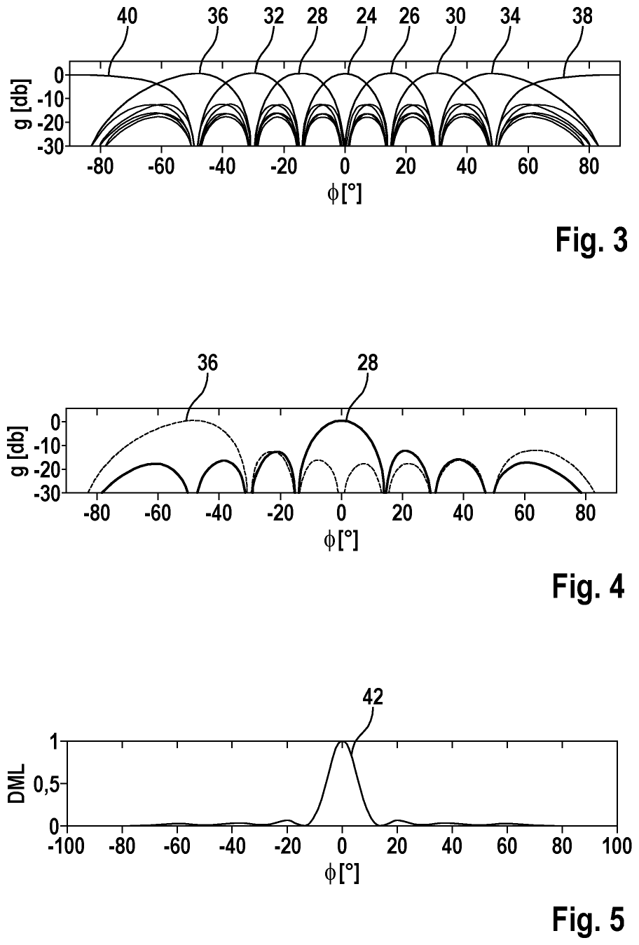

FIG. 3 is a diagram, in which for antenna array 24 according to FIG. 2 the antenna gain of beam forming device 20 is represented as a function of azimuth angle ϕ. The diagram shows, in particular, the graphs of standardized gain functions 28-40 for ten received beams, whose sensitivity maxima are 0°, +/−15°, +/−30°, +/−45° and beyond +/−60°. Each beam has a main lobe with a maximum gain and a plurality of secondary lobes, which are attenuated with approximately 13 dB. This diagram is based on a beam forming with the aid of an FFT with a rectangular window.

For reasons of clarity, the graphs of gain functions 28 and 36 are represented once again in isolation in FIG. 4. The graph of the gain function 28 is plotted in solid lines, whereas the graph of the gain function 36 is plotted in dotted lines. It is apparent that gain function 28 with the maximum at 0° has symmetrical secondary lobes, whereas the gain function for the beam with the sensitivity maximum at −45° is asymmetrical.

In the digital beam forming, a weighted sum is formed from the complex amplitudes of the signals received in the eight antenna elements 12, with complex weighting factors, which reflect the difference in run length from antenna element to antenna element. Since these differences in run length are a function of azimuth angle ϕ, a different set of weighting factors is obtained for each beam (having a sensitivity maximum at a particular azimuth angle). If an object is located at a given azimuth angle ϕ, then a signal whose intensity is proportional to gain function 28 is obtained in the beam having the sensitivity maximum at 0°, whereas for the same object, a signal which is proportional to gain function 36 is obtained in the beam having the sensitivity maximum at −45°. Accordingly, a value which is provided by the associated gain function is also obtained for each of the remaining beams.

The azimuth angle at which the located object is actually situated may be deduced from the different amplitude values that are obtained for the various beams after beam forming. For this purpose, the angle is sought at which the measured values best correlate with the values provided by the gain functions.

As an example, FIG. 5 shows a DML function 42 (Deterministic Maximum Likelihood Function), also referred to as angle spectrum, for a target, which is situated at azimuth angle ϕ 0°. DML function 42 specifies for each azimuth angle ϕ the correlation between the measured values and the gain functions for the various beams. The function is standardized in such a way that the maximum has value 1. It is apparent that DML function 42 has only one single clearly pronounced maximum at angle ϕ=0°, at which the located object is situated. If instead, a signal were received from an object, which is situated at angle ϕ=20°, the DML function would then be shifted in such a way that its maximum would be 20°.

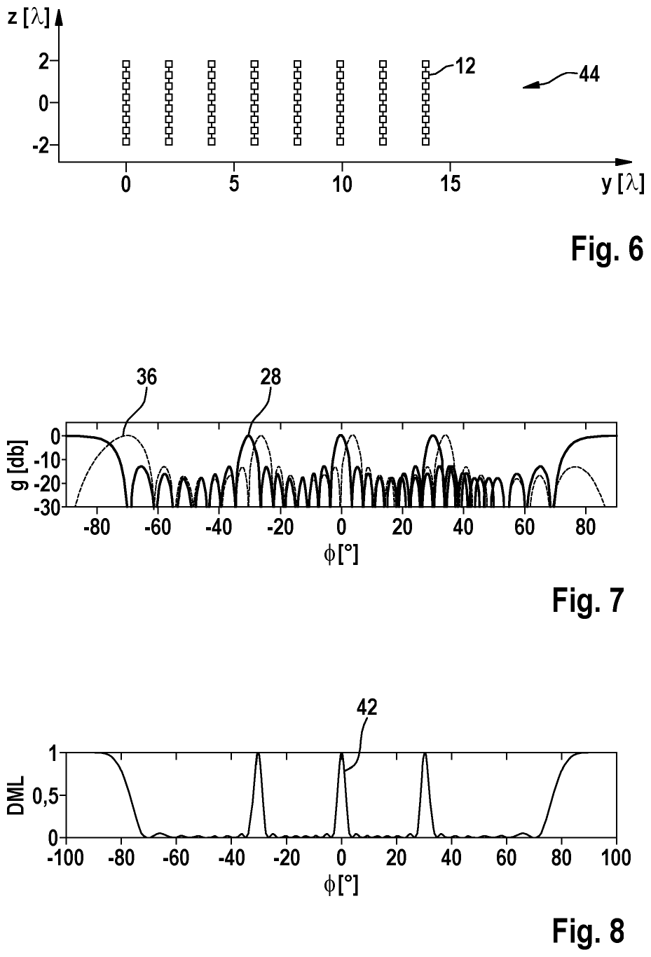

In order to improve the angle resolution capacity, the distances between antenna elements 12 are now increased to 2λ in ULA 24 according to FIG. 2 without, however, increasing the number of antenna elements. A ULA 44 having aperture A=14 is then obtained, as is shown in FIG. 6.

FIG. 7 shows how this change impacts the gain function 28-40. As in FIG. 4, the graphs for gain function 28 and 36 are also shown in FIG. 7. It is apparent that these gain functions each have multiple approximately equally high maxima. For example, gain function 28 has a maximum at 0° (as in FIG. 4), but further equally high maxima at +/−30°. Between these in each case is a larger number of more strongly attenuated secondary lobes. The same applies accordingly also to gain function 36 as well as for each other gain function (not shown in FIG. 7).

DML function 42 for the ULA according to FIG. 6 is shown in FIG. 8. This function also now has multiple equally high main lobe maxima, so that an unambiguous angle estimation is no longer possible.

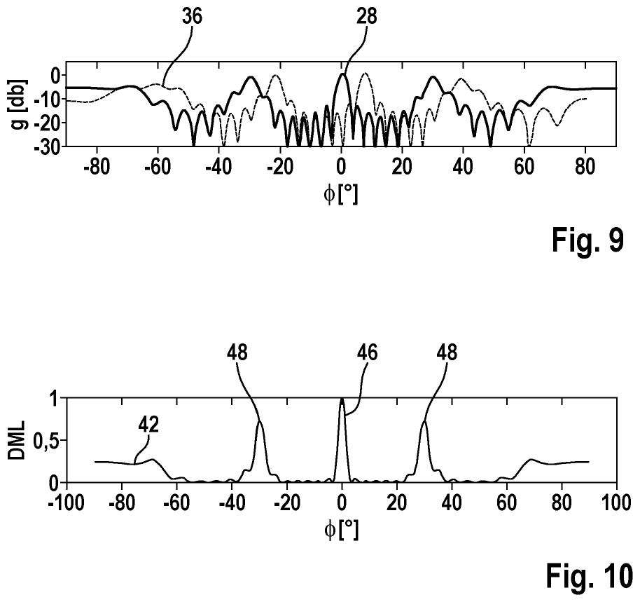

If, on the other hand, virtual regular antenna array 10 according to FIG. 1 is used, then unambiguous angle estimations are again possible. Gain functions 28 and 36 for this array are shown in FIG. 9. As in FIG. 7, each gain function has three pronounced main maxima in the angle range of −50° to +50°, but the secondary lobes in this case are more strongly “shouldered,” i.e., the secondary lobes are increased and moved closer to the shoulders of the main maxima.

FIG. 10 shows associated DML function 42. Since the beam forming in beam forming device 20 occurs in the same manner as in the ULAs according to FIGS. 2 and 6, with the same weighting factors, but the distances between adjacent antenna elements 12 are slightly uneven, only one main maximum 46 at ϕ=0° (in the case of a target at 0°) remains at full height, whereas flanking maxima 48 at +/−30° are more strongly suppressed. This means that during an angle estimation, an unambiguous maximum is found and thus an unambiguous angle estimation is possible.

Erroneous angle estimations may occur at most if the signals are so noisy that the differences between maxima 46 and 48 are blurred and one of maxima 48 has the highest value and is erroneously selected for determining the azimuth angle. The more uneven the distances are between adjacent antenna elements 12, the more strongly maxima 48 are suppressed, and the more robust the angle estimation is with respect to the signal noise. On the other hand, however, the secondary lobes become increasingly more pronounced with increasing unevenness of the arrays. A suitable selection of the unevenness of the distances between antenna elements 12, however, means that an unambiguous angle estimation is possible with the normally present signal noise and a higher angle resolution is achieved due to the enlarged aperture without the need for additional evaluation channels.

1-7. (canceled)

8. An angle-resolving radar sensor, comprising:
an antenna array which includes a number N of antenna elements offset relative to one another in a scanning direction;
a digital beam forming device; and
an angle estimating device configured to estimate an angle based on a signal of the beam forming device;
wherein an aperture A of the antenna array is greater than (N−1)/2 in units of wavelength λ, and center-to-center distances between adjacent antenna elements of the antenna elements differ from one another, but deviate by not more than a predetermined degree of a value A/(N−1).

9. The radar sensor as recited in claim 8, wherein the distances for the adjacent antenna elements deviate by not more than 25% of the value A/(N−1).

10. The radar sensor as recited in claim 8, wherein the distances for the adjacent antenna elements deviate by not more than 15% of the value A/(N−1).

11. The radar sensor as recited in claim 8, wherein distances between the antenna elements vary according to a regular pattern.

12. The radar sensor as recited in claim 11, wherein the distances between the antenna elements vary according to a polynomial function.

13. The radar sensor as recited in claim 12, wherein the distances between the antenna elements vary according to a linear function.

14. The radar sensor as recited in claim 8, wherein N is a power of two.

15. The radar sensor as recited in claim 8, wherein A≥1.

16. The radar sensor as recited in claim 8, wherein A≥2.
